(19) United States
(12) Patent Application Publication
(10) Pub. No.: US 2017/0269595 A1
(43) Pub. Date: Sep. 21, 2017

(54) SYSTEM OF COLLISION-PROOFING, COLLISION-DEFERRING AND WALLSIDE-TRACKING FOR A SELF-PROPELLED APPARATUS

(71) Applicant: Lumiplus Technology (Suzhou) Co., Ltd., Suzhou (CN)

(72) Inventor: SHUN-YI CHEN, Taipei City (TW)

(21) Appl. No.: 15/134,872

(22) Filed: Apr. 21, 2016

(30) Foreign Application Priority Data
Mar. 15, 2016 (TW) 105203534

(51) Int. Cl. G05D 1/00; G05D 1/02

(52) U.S. Cl. CPC G05D 1/0088; G05D 1/0255; G05D 2201/0203

(57) ABSTRACT

A system of collision-proofing, collision-deferring and wallside-tracking for a self-propelled apparatus includes a main body, a control unit and a detection unit. The control unit is located at the main body. The detection unit is also located at the main body and electrically couples the control unit. The detection unit has a first detection mode and a second detection mode. On the first detection mode, if the detection unit receives a turning reference signal value reflected from an obstacle, the control unit controls the main body to walk away the obstacle. On the second detection mode, the detection unit applies an ultrasonic signal to detect a distance value between the main body and the obstacle, and the control unit controls the main body to walk away the obstacle if the distance value is smaller than a threshold value.

This application claims the benefit of Taiwan Patent Application Serial No. 105203534, filed Mar. 15, 2016, the subject matter of which is incorporated herein by reference.

### BACKGROUND OF INVENTION

1. Field of the Invention

The invention relates to a system of collision-proofing, collision-deferring and wallside-tracking, and more particularly to the system of collision-proofing, collision-deferring and wallside-tracking for a self-propelled apparatus.

2. Description of the Prior Art

In household cleaning, a self-propelled apparatus, named also as a robotic cleaner, is popular recently. The robotic cleaner can “walk” on the floor automatically, and clean the floor at the same time.

For the self-propelled apparatus to walk purposely, preset paths are assigned in advance, or preset images are provided in advance for later identification so as to determine thereby the forward direction, the speed and the travel distance. However, since the interior arrangement varies all the time, including objects inside and the corresponding locations occupied, thus, even in the same room, the self-propelled apparatus may encounter different environments from time to time. Thus, the aforesaid setting for the self-propelled apparatus to follow the same travelling path would be meaningless to meet practical needs.

Currently, in order to have the self-propelled apparatus not to hit or collide any obstacle while in walking, and to resolve the aforesaid environment-varying problem to some degrees, a concept of virtual walls is applied to define a pseudo wall to each prohibited area. When the self-propelled apparatus receives signals related to any of the virtual walls, it will walk back off or detour so as not to hit the virtual wall that defining the prohibited area. In addition, a soft pad may be also applied to buffer possible collision and impact and to reduce possible damage, upon when the self-propelled apparatus hits the obstacle.

### SUMMARY OF THE INVENTION

Accordingly, it is the primary object of the present invention to provide a system of collision-proofing, collision-deferring and wallside-tracking for a self-propelled apparatus that can reduce the possibility of the self-propelled apparatus failing to receive signals, and can thus enhance performance in collision-proofing and collision-deferring.

In the present invention, the system of collision-proofing, collision-deferring and wallside-tracking for a self-propelled apparatus includes a main body, a control unit and a detection unit. The control unit is located at the main body. The detection unit is also located at the main body and electrically couples the control unit. The detection unit has a first detection mode and a second detection mode. On the first detection mode, if the detection unit receives a turning reference signal value reflected from an obstacle, the control unit controls the main body to walk away the obstacle. On the second detection mode, the detection unit applies an ultrasonic signal to detect a distance value between the main body and the obstacle, and the control unit controls the main body to walk away the obstacle if the distance value is smaller than a threshold value.

In one embodiment of the present invention, the control unit further includes a wallside-tracking control module and a third detection mode, the wallside-tracking module being located at one side of the main body and electrically coupled with the detection unit; wherein, on the third detection mode, when the detection unit receives the turning reference signal value reflected from the obstacle, the wallside-tracking control module control the main body to walk away the obstacle; wherein, when the detection unit does not receive the turning reference signal value reflected from the obstacle, the wallside-tracking control module controls the main body to walk closer toward the obstacle.

In one embodiment of the present invention, the control unit further includes a speed control module; wherein, on the second detection mode, when the distance value is larger than the threshold value, the speed control module controls the main body to walk closer toward the obstacle so as to reduce the distance value between the main body and the obstacle.

In one embodiment of the present invention, the detection unit further includes an infrared detection unit, the infrared detection unit having an infrared emitter and an infrared receiver, the infrared emitter being located at the main body for emitting an infrared signal to the obstacle, the infrared receiver being located at the main body for receiving the turning reference signal value of the reflected infrared signal from the obstacle.

In one embodiment of the present invention, the self-propelled apparatus further includes a turning member located at the main body; wherein, when the detection unit receives the turning reference signal value reflected from the obstacle, the main body turns or backs off so as to walk away the obstacle.

By providing the system of collision-proofing, collision-deferring and wallside-tracking for a self-propelled apparatus in the present invention, the first detection mode and the second detection mode can be applied simultaneously to detect the obstacle, in which the first detection mode applies the infrared signal, and the second detection mode applies the ultrasonic signal. When the detection unit receives the turning reference signal value calculated from the reflected signal from the obstacle, the control unit would control the main body to walk away or simply not to get closer to the obstacle, such that the design object in anti-collision can be obtained.

Further, when the obstacle is a black wall or a wall with poor reflectivity, the second detection mode can be introduced to emit the ultrasonic signal to detect the area that the operation of the first detection mode cannot reach. Thereupon, the overall collision-proofing and collision-deferring functions of the self-propelled apparatus can be significantly enhanced.

All these objects are achieved by the system of collision-proofing, collision-deferring and wallside-tracking for a self-propelled apparatus described below.

### BRIEF DESCRIPTION OF THE DRAWINGS

The present invention will now be specified with reference to its preferred embodiment illustrated in the drawings, in which:

FIG. 1 is a schematic view of a preferred system of collision-proofing, collision-deferring and wallside-tracking for a self-propelled apparatus in accordance with the present invention;

FIG. 2 is a schematic block view showing internal components of FIG. 1;

FIG. 3 demonstrates schematically a collision-proofing operation of the system of collision-proofing, collision-deferring and wallside-tracking for a self-propelled apparatus of FIG. 1;

FIG. 4 demonstrates schematically the system of collision-proofing, collision-deferring and wallside-tracking for a self-propelled apparatus of FIG. 1 on a walk mode;

FIG. 5 demonstrates schematically the system of collision-proofing, collision-deferring and wallside-tracking for a self-propelled apparatus of FIG. 1 in a state of a third detection mode; and

FIG. 6 demonstrates schematically the system of collision-proofing, collision-deferring and wallside-tracking for a self-propelled apparatus of FIG. 1 in another state of the third detection mode.

### DESCRIPTION OF THE PREFERRED EMBODIMENT

The invention disclosed herein is directed to a system of collision-proofing, collision-deferring and wallside-tracking for a self-propelled apparatus. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

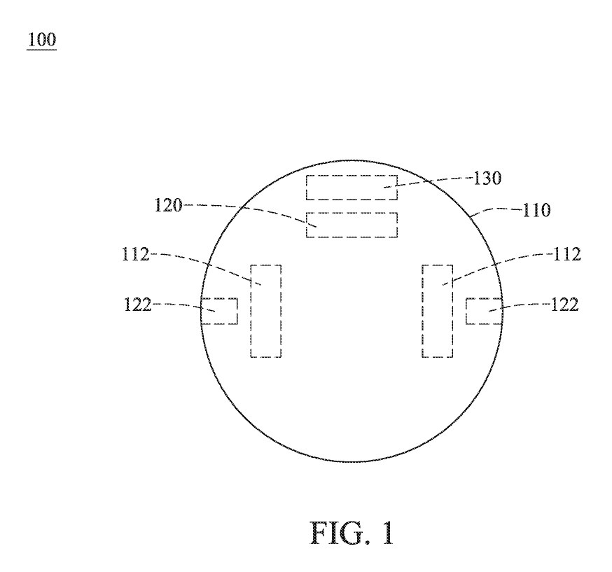

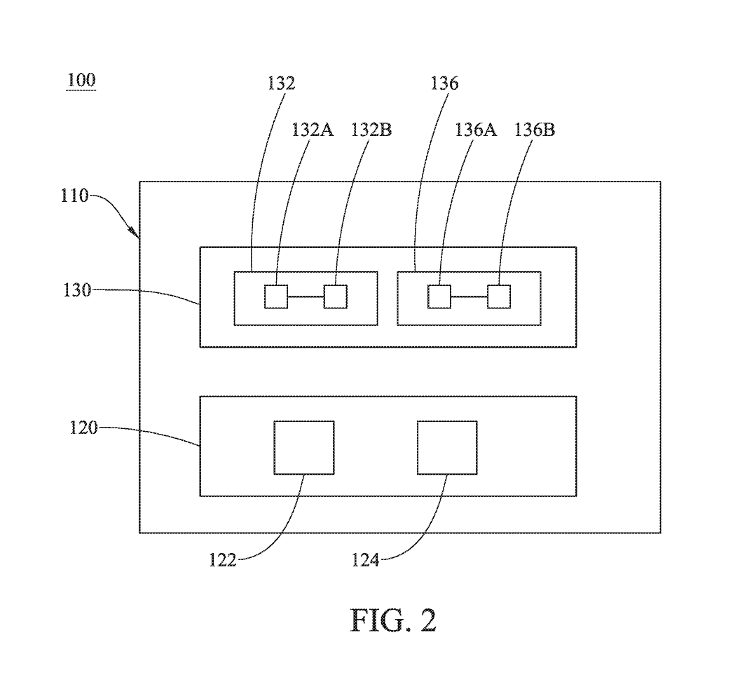

Refer now to FIG. 1 and FIG. 2; where FIG. 1 is a schematic view of a preferred system of collision-proofing, collision-deferring and wallside-tracking for a self-propelled apparatus in accordance with the present invention, and FIG. 2 is a schematic block view showing internal components of FIG. 1. In the present invention, the system 100 of collision-proofing, collision-deferring and wallside-tracking for a self-propelled apparatus has all functions of anti-collision, delaying the collision and tracking along the wall. The system of collision-proofing, collision-deferring and wallside-tracking for a self-propelled apparatus 100 includes a main body 110, a control unit 120 and a detection unit 130. The main body 110 can be formed as, but not limited to, a robotic cleaner. In some other embodiments, the self-propelled apparatus 110 can be a vehicle with self-propelling capability.

The main body 110 includes a turning member 112, such as a walk wheel on the main body 110 for “walking” on the floor. By providing the turning member 112, the main body 110 can turn by itself.

The control unit 120 is located at the main body 110. The detection unit 130 is located also at the main body 110. In addition, the control unit 120 is coupled with the detection unit 130.

The control unit 120 of the present invention includes a wallside-tracking control module 122 and a speed control module 124.

The wallside-tracking control module 122 located at a side of the main body 110 is electrically coupled with the detection unit 130.

The speed control module 124 located inside the control unit 120 of the main body 110 is electrically coupled with the detection unit 130.

In practice, the detection unit 130 can include an infrared detection unit 132 and an ultrasonic detection unit 136.

The infrared detection unit 132 includes an infrared emitter 132A and an infrared receiver 132B, in which the infrared emitter 132A is electrically coupled with the infrared receiver 132B.

The infrared emitter 132A for emitting an infrared signal to an obstacle is located at the main body 110.

The infrared receiver 132B is located at the main body 110. After the obstacle reflects the infrared signal, the reflected infrared signal is further processed by a digital filter so as thereby to obtain a turning reference signal value. When the turning reference signal value is greater than a threshold value or the reflected infrared signal meets a specific frequency, the infrared receiver 132B is applied to receive the turning reference signal value calculated from the infrared signal reflected by the obstacle.

The ultrasonic detection unit 136 includes an ultrasonic emitter 136A and an ultrasonic receiver 136B, in which the ultrasonic emitter 136A is electrically coupled with the ultrasonic receiver 136B.

The ultrasonic emitter 136A and the ultrasonic receiver 136B are both located at the main body 110. The ultrasonic emitter 136A for emitting an ultrasonic signal to the obstacle. The ultrasonic signal reflected by the obstacle is further processed by a digital filter so as thereby to obtain a reflection value. The ultrasonic receiver 136B is to receive the reflection value. Therefore, in this embodiment, by calculating a time difference between the ultrasonic signal emitted by the ultrasonic emitter 136A and that received by the ultrasonic receiver 136B, a distance value between the main body 110 and the obstacle can then be realized. Also, before the ultrasonic receiver 136B receives the reflected ultrasonic signal from the obstacle, the reflected ultrasonic signal is firstly processed by the digital filter so as to determine if or not the frequency of the reflected ultrasonic signal meets the required frequency for emission, such that the possibility for the ultrasonic receiver 136B to receive a fault or fake ultrasonic signal can be reduced to a minimum.

The detection unit 130 includes a first detection mode, a second detection mode and a third detection mode.

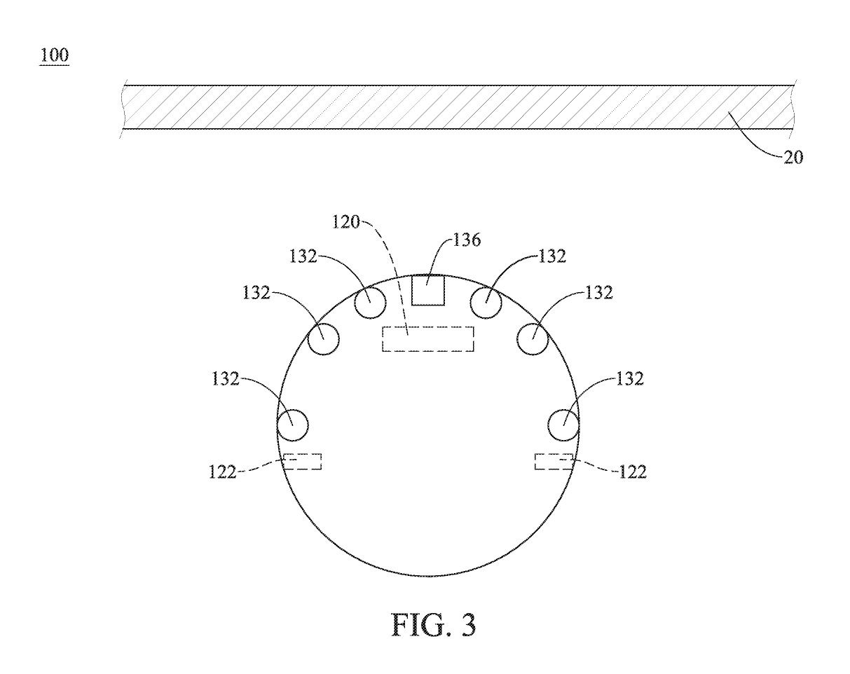

Referring now to FIG. 3, a collision-proofing operation of the system of collision-proofing, collision-deferring and wallside-tracking for a self-propelled apparatus of FIG. 1 is schematically demonstrated. In this embodiment, a plurality of the infrared detection units 132 (six shown in FIG. 3) is arranged individually at the main body 110, and two wallside-tracking control modules 122 are located to opposing sides of the main body 110 by neighboring to two of the infrared detection units 132, respectively.

On the first detection mode, when the detection unit 130 receives the turning reference signal value calculated from the ultrasonic signal reflected by the obstacle 20, the control unit 120 would control the main body 110 to walk away or at least not to get closer to the obstacle 20. It shall be explained that the so-called obstacle 20 herein is referred to a wall. However, in other applications, the obstacle can be a solid object or any kind of real or pseudo objects.

Referring to FIG. 2 and FIG. 3, the infrared emitter 132A in each of the infrared detection units 132 can emit its own infrared signal to the obstacle 20. When the infrared receiver 132B of the infrared detection unit 132 receives the turning reference signal value calculated from the ultrasonic signal reflected by the obstacle 20, the control unit 120 would control the main body 110 to walk away or simply not to get closer to the obstacle 20. Typically, the main body 110 can turn or back off to avoid possible collision with the obstacle 20.

On the second detection mode, the detection unit 130 applies an ultrasonic signal to detect the distance value between the main body 110 and the obstacle. In detail, the ultrasonic emitter 136A is applied to emit an ultrasonic signal to the obstacle, and the reflected ultrasonic signal reflected by the obstacle is then received and processed by a digital filter so as to obtain a corresponding reflection value. The ultrasonic receiver 136B then receives the reflection value. By evaluating the time difference between the emission of the signal at the ultrasonic emitter 136A and the receipt of the reflected signal at the ultrasonic receiver 136B, the distance value between the main body 110 and the obstacle can then be calculated. When the distance value is lower than a threshold value, the control unit 120 would control the main body 110 to walk away or simply not to get closer to the obstacle 20.

It shall be noted that the aforesaid first detection mode and second detection mode can perform the detection synchronously. In the case that the obstacle 20 is a black wall or a wall with poor reflectivity, the second detection mode can be introduced to detect the area that the operation of the first detection mode cannot reach.

Referring to both FIG. 2 and FIG. 3, the infrared emitter 132A in each of the infrared detection units 132 can emit a corresponding infrared signal to the obstacle 20. In the case that the obstacle 20 is a black wall or a wall with poor reflectivity, the infrared signal may be easily absorbed by the wall, and thus a lower turning reference signal value calculated from the reflected infrared signal by the obstacle 20 can be received by the infrared receiver 132B of the infrared detection unit 132. At this time, the ultrasonic detection unit 136 can use the time difference between the emission and reception of the ultrasonic signal at the ultrasonic emitter 136A and the ultrasonic receiver 136B, respectively, to calculate the distance value between the main body 110 and the obstacle. When the distance value is lower than a threshold value, namely a distance that the main body 110 can't approach the obstacle 20 anymore, then the control unit 120 would control the main body 110 to turn or back off from the obstacle 20, such that no collision between the main body 110 and the obstacle 20 can occur. Upon such an arrangement, even in the case that the obstacle 20 is a black wall or a wall with poor reflectivity, the second detection mode can be still applied to perform an ultrasonic detection, and thus the area that the operation of the first detection mode cannot reach can be reduced to a minimum. Importantly, thereby, the collision between the main body and the obstacle can be effectively inhibited.

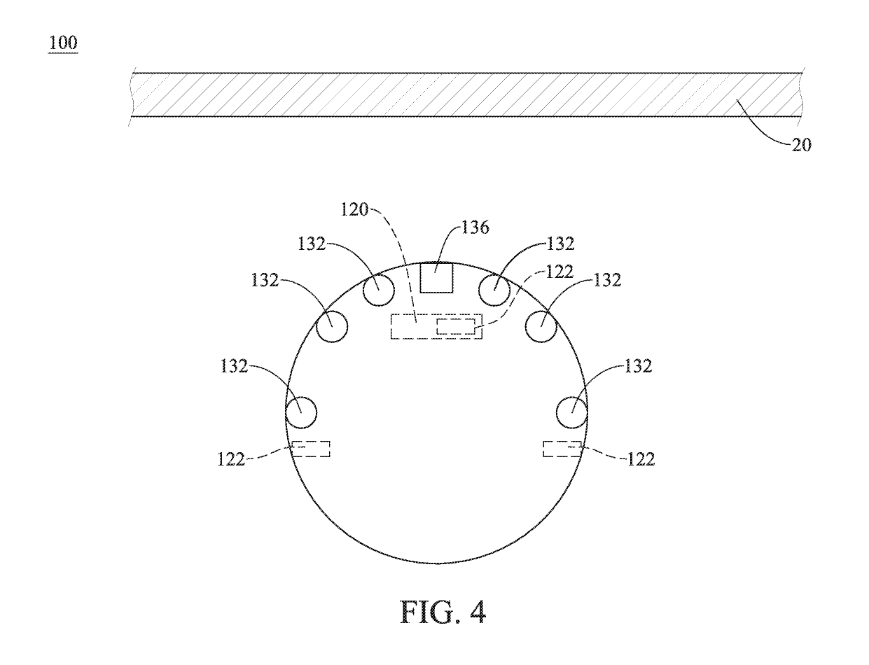

Referring now to FIG. 4, the system of collision-proofing, collision-deferring and wallside-tracking for a self-propelled apparatus of FIG. 1 on a walk mode is demonstrated schematically.

Further, when the aforesaid distance value is larger than the threshold value, the speed control module 124 would control the main body 110 to get close to the obstacle 20 so as to shorten the distance value between the main body 110 and the obstacle 20.

Referring now to both FIG. 4 and FIG. 2, when the main body 110 is needed to walk closer to the obstacle 20, the main body 110 would walk in a direction facing the obstacle 20 so as to shorten gradually the distance value between the main body 110 and the obstacle 20. Till when the distance value is smaller than the threshold value, the control unit 120 would control the main body 110 to walk away or simply not to get closer to the obstacle 20. In another embodiment, when the aforesaid distance value is smaller than the threshold value, the speed control module 124 is applied to gradually slow the speed of the main body 110 so as thereby to shorten gradually the distance value between the main body 110 and the obstacle 20. Thus, the purpose of deferring the collision in between can be obtained. Further, the main body 110 can further include a switch for the user to choose arbitrarily the collision-proofing mode or the collision-deferring mode.

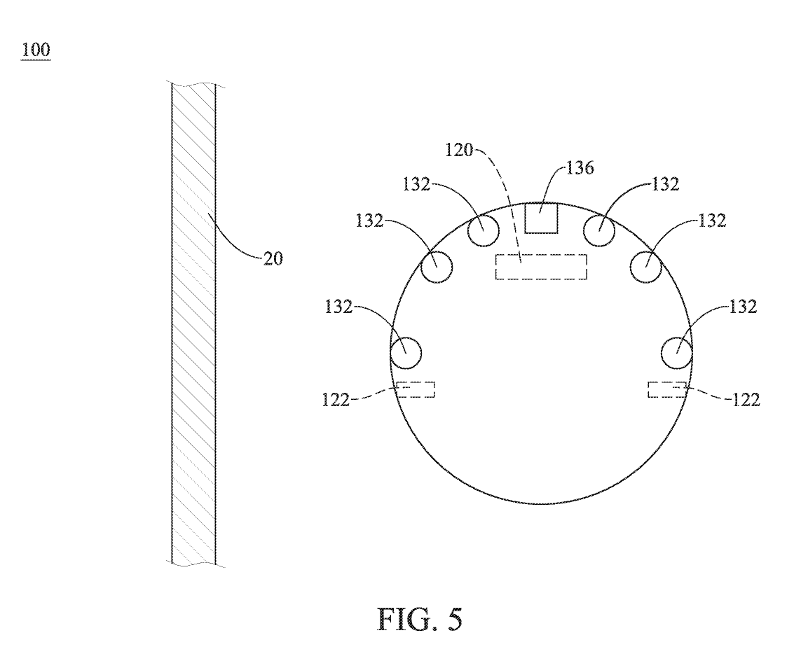

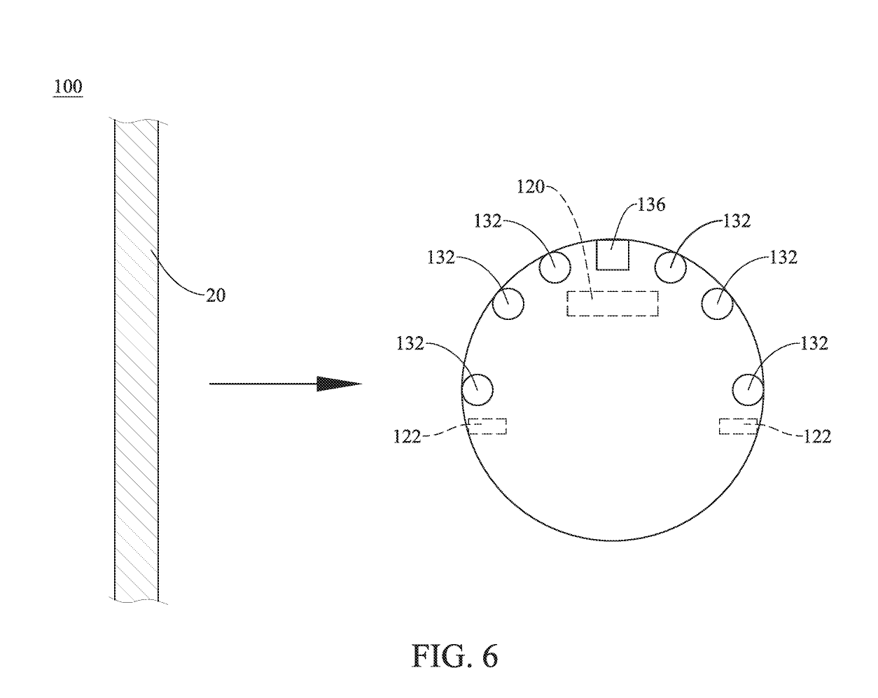

Refer now to FIG. 5 and FIG. 8; where FIG. 5 demonstrates schematically the system of collision-proofing, collision-deferring and wallside-tracking for a self-propelled apparatus of FIG. 1 in a state of a third detection mode, and FIG. 6 demonstrates schematically the system of collision-proofing, collision-deferring and wallside-tracking for a self-propelled apparatus of FIG. 1 in another state of the third detection mode.

In particular, one of the infrared detection units 132 located at the side of the main body 110 is perpendicular to the obstacle 20. On the third detection mode, as shown in FIG. 5, the main body 110 can perform a wallside-tracking mode to walk along the obstacle 20. After the detection unit 130 receives the turning reference signal value calculated from the reflected signal from the obstacle 20, the wallside-tracking control module 122 would control the main body 110 to walk along the obstacle 20 by specific spacing or to walk away the obstacle 20.

As shown in FIG. 6, the main body 110 at this timing is spaced from the obstacle 20 by a larger distance, and thus the detection unit 130 doesn't receive any turning reference signal value reflected from the obstacle 20. At this time, the wallside-tracking control module 122 would control the main body 110 to walk closer toward the obstacle 20, till the detection unit 130 as shown in FIG. 5 receives the turning reference signal value calculated from the reflected signal from the obstacle 20.

In summary, by providing the system of collision-proofing, collision-deferring and wallside-tracking for a self-propelled apparatus in the present invention, the first detection mode and the second detection mode can be applied simultaneously to detect the obstacle, in which the first detection mode applies the infrared signal, and the second detection mode applies the ultrasonic signal. When the detection unit receives the turning reference signal value calculated from the reflected signal from the obstacle, the control unit would control the main body to walk away or simply not to get closer to the obstacle, such that the design object in anti-collision can be obtained.

Further, when the obstacle is a black wall or a wall with poor reflectivity, the second detection mode can be introduced to emit the ultrasonic signal to detect the area that the operation of the first detection mode cannot reach. Thereupon, the overall anti-collision protection on the self-propelled apparatus can be enhanced.

In addition, when the self-propelled apparatus is on a wallside-tracking mode, as the detection unit receives the turning reference signal value calculated from the reflected signal from the obstacle, the wallside-tracking control module would control the main body to walk along the obstacle by specific spacing or to walk away the obstacle. While the detection unit doesn't receive any turning reference signal value reflected from the obstacle, the wallside-tracking control module would control the main body to walk closer toward the obstacle, till the detection unit receives the turning reference signal value calculated from the reflected signal from the obstacle. Reciprocally, the self-propelled apparatus can then walk along the wall.

While the present invention has been particularly shown and described with reference to a preferred embodiment, it will be understood by those skilled in the art that various changes in form and detail may be without departing from the spirit and scope of the present invention.

What is claimed is:

1. A system of collision-proofing, collision-deferring and wallside-tracking for a self-propelled apparatus, comprising:
a main body;
a control unit, locate at the main body; and
a detection unit, located at the main body, electrically coupling the control unit, further including a first detection mode and a second detection mode;
wherein, on the first detection mode, if the detection unit receives a turning reference signal value reflected from an obstacle, the control unit controls the main body to walk away the obstacle;
wherein, on the second detection mode, the detection unit applies an ultrasonic signal to detect a distance value between the main body and the obstacle, and the control unit controls the main body to walk away the obstacle if the distance value is smaller than a threshold value.

2. The system of collision-proofing, collision-deferring and wallside-tracking for a self-propelled apparatus of claim 1, wherein the control unit further includes a wallside-tracking control module and a third detection mode, the wallside-tracking module being located at one side of the main body and electrically coupled with the detection unit; wherein, on the third detection mode, when the detection unit receives the turning reference signal value reflected from the obstacle, the wallside-tracking control module control the main body to walk away the obstacle; wherein, when the detection unit does not receive the turning reference signal value reflected from the obstacle, the wallside-tracking control module controls the main body to walk closer toward the obstacle.

3. The system of collision-proofing, collision-deferring and wallside-tracking for a self-propelled apparatus of claim 1, wherein the control unit further includes a speed control module; wherein, on the second detection mode, when the distance value is larger than the threshold value, the speed control module controls the main body to walk closer toward the obstacle so as to reduce the distance value between the main body and the obstacle.

4. The system of collision-proofing, collision-deferring and wallside-tracking for a self-propelled apparatus of claim 1, wherein the detection unit further includes an infrared detection unit, the infrared detection unit having an infrared emitter and an infrared receiver, the infrared emitter being located at the main body for emitting an infrared signal to the obstacle, the infrared receiver being located at the main body for receiving the turning reference signal value of the reflected infrared signal from the obstacle.

5. The system of collision-proofing, collision-deferring and wallside-tracking for a self-propelled apparatus of claim 1, wherein the self-propelled apparatus further includes a turning member located at the main body; wherein, when the detection unit receives the turning reference signal value reflected from the obstacle, the main body turns or backs off so as to walk away the obstacle.
